(19) United States
(12) Patent Application Publication
(10) Pub. No.: US 2004/0077774 A1
(43) Pub. Date: Apr. 22, 2004

(54) Alkyl and aryl alkoxylates as emulsifiers in emulsion polymerisation

(76) Inventors: Hendrik Ahrens, Frankfurt am Main (DE); Uwe Falk, Bruchkoebel (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/467,394

(22) PCT Filed: Jan. 29, 2002
(86) PCT No.: PCT/EP02/00880

(51) Int. Cl. C08J 3/00

(52) U.S. Cl. 524/556

(57) ABSTRACT

The invention relates to the use of compounds of formula (1) as emulsifiers in emulsion polymerisation. In said formula. R₁ represents an alkyl or alkenyl group with between 1 and 8 carbon atoms, or a phenyl, methylphenyl or dimethylphenyl group, R₂ represents a methyl or ethyl group, R₃ represents a hydrogen atom or a methyl group, x is a number from 1 to 50 and y is a number from 1 to 500.

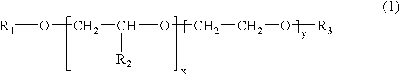

The present invention relates to the use of alkyl and aryl alkoxylates as emulsifiers in emulsion polymerizations.

The emulsifiers used for emulsion polymerization according to the prior art are mostly anionic and nonionic emulsifiers.

Customary anionic emulsifiers are sodium, potassium and ammonium salts of fatty acids, sodium alkylbenzenesulfonates, sodium alkylsulfonates, sodium olefinsulfonates, sodium polynaphthalenesulfonates, sodium dialkyl diphenyl ether disulfonates, sodium, potassium and ammonium alkyl sulfates, sodium, potassium and ammonium alkylpolyethylene glycol ether sulfates, sodium, potassium and ammonium alkylphenol polyethylene glycol ether sulfates, sodium, potassium and ammonium mono- and dialkylsulfosuccinates and monoalkyl polyoxethylsulfosuccinates, and alkylpolyethylene glycol ether phosphoric mono-, di- and triesters and mixtures thereof and alkylphenol polyethylene glycol ether phosphoric mono-, di- and triesters and mixtures thereof, and the sodium, potassium and ammonium salts thereof.

The nonionic emulsifiers used are usually alkylphenol polyethylene glycol ethers, alkylpolyethylene glycol ethers, fatty acid polyethylene glycol ethers, ethylene/propylene glycol block polymers and sorbitan ester polyethylene glycol ethers.

Emulsion polymerizations are carried out using anionic and nonionic emulsifiers usually where the initial charge is the whole mixture or in a feed process in which only a small part of the monomers to be polymerized is initially introduced into the polymerization vessel and the greater part (50 to 100% by weight) is added during the course of the polymerization. The anionic or nonionic emulsifiers are introduced as desired during the emulsion polymerization in the feed or in the reactor initial charge, or are added subsequently to the prepared polymer dispersion to achieve stabilization.

The prior art describes various types of emulsifiers for emulsion polymerization.

DE-A-42 06 429 discloses the use of mixtures of ethylene oxide/propylene oxide block polymers, ethoxylated alkylphenols and ethoxylated polysaccharides as emulsifier for emulsion polymerizations. The block polymers contain a polypropylene glycol block which is flanked by two polyethylene glycol blocks and have a number-average molecular weight of from 250 to 20 000, and contain ethylene oxide (EO) and propylene oxide (PO) in the molar ratio of EO:PO of from 0.05 to 20. The alkylphenols disclosed therein contain only EO units and no PO units and, due to the lack of surface-active properties of the EO units, have to carry longer-chain alkyl substituents on the aromatic moiety.

EP 0 894 809 A2 describes the use of alkylaryl polyglycol ethers and alkyl polyglycol ethers having in each case 3 to 50 mol of EO units as emulsifier for emulsion polymerizations. A use of PO units is not disclosed. Here too, the use of long alkyl and alkylaryl chains is necessary.

EP 0 279 384 B1 describes the use of a polyethoxylated derivative of a long-chain alkylphenol having 30 to 40 ethylene oxide units in which the alkyl group comprises 7 to 18 carbon atoms as emulsifier. The document also discloses the use of polyoxyethylene ethanol and polyoxypropylene ethanol, but not the use of mixed alkoxylates as emulsifiers.

EP 0 457 642 A1 describes the use of EO/PO block polymers and of trisec-butylphenol polyethylene glycol ethers having 4 and 30 mol of ethylene oxide units as emulsifier for the emulsion polymerization of chloroprene. Branched substitution of the aromatic moiety is necessary here due to the lack of surface-active properties of the EO chains. The document further discloses the use of mixed-alkoxylated esters and amides as emulsifiers, but not a corresponding suitability of carbonyl-free mixed alkoxylates.

DE 195 03 099 A1 describes the corresponding use of nonionic emulsifiers of the alkyl polyalkylene glycol ether type, where the advantage of a mixed alkoxylation for short-chain, hydrophilic alkyl radicals is not stated in concrete terms. A characteristic of these compounds is that their cloud point is below the polymerization temperature. Preference is given to alkylpolyethylene glycol ethers which contain alkyl groups having 4 to 24 carbon atoms and 2 to 14 mol of ethylene oxide units, and no PO. A mixed alkoxylation is only disclosed for the fatty alkylpolyalkylene glycol ethers derived from hydrophobic fatty alcohols.

It was therefore an object of the present invention to find novel emulsifiers for emulsion polymerization which ensure improved physicochemical stability of the emulsion polymers. In this connection, it was in particular the intention to ensure that no expensive constituents, such as, for example, fatty alcohols or aromatics substituted by radicals longer than methyl radicals, are necessary for their preparation.

It has now been found that stable and low-coagulum polymer dispersions can be prepared using alkyl and aryl alkoxylates which have a mixed alkoxylation of ethylene oxide (EO) on the one hand and propylene oxide/butylene oxide (PO/BuO) on the other hand as emulsifiers in the emulsion polymerization.

The invention thus provides for the use of compounds of the formula 1

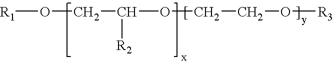

in which

R₁ is an alkyl or alkenyl radical having 1 to 8 carbon atoms or a phenyl, methyl phenyl or dimethyl phenyl radical,

R₂ is a methyl or ethyl radical,

R₃ is a hydrogen atom or a methyl radical,

x is a number from 1 to 50 and

y is a number from 1 to 500,

as emulsifier in emulsion polymerization.

In a preferred embodiment, R₁ is an alkyl or alkenyl radical. R₁ preferably has between 1 and 6, in particular between 1 and 4, carbon atoms. The alcohol from which the emulsifier according to the invention can be derived by alkoxylation is preferably a hydrophilic alcohol. Hydrophilic is understood here as meaning a miscibility of the alcohol with water in amounts of at least 0.01% by weight, preferably 0.05% by weight, in particular 0.1% by weight, especially 0.3% by weight.

In a further preferred embodiment of the invention, x is between 2 and 30. In a further preferred embodiment of the invention, y is between 10 and 100. In a further preferred embodiment of the invention, the ratio between x and y of x:y is 1:10 to 1:2.

The invention further provides a process for the preparation of emulsion polymers, which comprises the addition of a compound of the formula 1 before, during or after the start of the polymerization reaction.

In a particularly preferred embodiment, the invention relates to the use of alkyl and aryl alkoxylates of the formula (1) for the preparation of stable polymer dispersions in the polymerization of olefinically unsaturated compounds, as shall now be described.

The monomers used for the preparation of polymer dispersions by the emulsion polymerization process are, for example,

vinyl monomers, such as carboxylic esters of vinyl alcohol, for example vinyl acetate, vinyl propionate, vinyl ether of isononanoic acid or of isodecanoic acid,

aryl-substituted olefins, such as styrene and stilbene

olefinically unsaturated carboxylic esters, such as methyl acrylate, ethyl acrylate, propyl acrylate, n-butyl acrylate, i-butyl acrylate, pentyl acrylate, hexyl acrylate, 2-ethylhexyl acrylate, hydroxyethyl acrylate, and the corresponding methacrylic esters,

olefinically unsaturated dicarboxylic esters, such as dimethyl maleate, diethyl maleate, dipropyl maleate, dibutyl maleate, dipentyl maleate, dihexyl maleate and di-2-ethylhexyl maleate,

olefinically unsaturated carboxylic acids and dicarboxylic acids, such as acrylic acid, methacrylic acid, itaconic acid, maleic acid and fumaric acid and their sodium, potassium and ammonium salts,

olefinically unsaturated sulfonic acids and phosphonic acids and their alkali metal and ammonium salts, such as acrylamidomethyl-propanesulfonic acid and its alkali metal and ammonium, alkylammonium and hydroxyalkylammonium salts, allylsulfonic acid and its alkali metal and ammonium salts, acryloyloxethylphosphonic acid and its ammonium and alkali metal salts, and the corresponding methacrylic acid derivatives,

olefinically unsaturated amines, ammonium salts, nitriles and amides, such as dimethylaminoethyl acrylate, acryloyloxyethyl-trimethylammonium halides, acrylonitrile, N-methylacrylamide, N-ethylacrylamide, N-propylacrylamide, N-methylolacrylamide, and the corresponding methacrylic acid derivatives and vinylmethyl-acetamide.

In a preferred embodiment, the abovementioned monomers are polymerized with further comonomers, preferably olefins or halogenated olefins having 2 to 8 carbon atoms, such as, for example, ethylene, propene, butenes, pentenes, 1,3-butadiene, chloroprene, vinyl chloride, vinylidene chloride, vinylidene fluoride and tetrafluoroethylene.

To prepare the polymer dispersions, the water-immiscible monomers are generally finely distributed in the aqueous phase in the form of micelles using the emulsifiers according to the invention, and the free-radical polymerization reaction is started by initiators, such as, for example, ammonium, sodium and potassium peroxodisulfate.

Further auxiliaries and additives for use with the emulsifiers according to the invention may be protective colloids, such as carboxymethyl cellulose, hydroxyethyl cellulose, methyl-hydroxypropyl cellulose and partially and completely hydrolyzed polyvinyl alcohol.

A review of common processes, surfactants and further auxiliaries of emulsion polymerization is given by Peter A. Lovell and Mohamed S. El-Aasser, in “Emulsion Polymerization and Emulsion Polymers”, published by John Wiley and Sons, 1997.

The alkyl and arylalkoxylates according to the invention can be used during the emulsion polymerization by initially introducing them into the reaction vessel prior to the start of the polymerization reaction, or by adding them to the reaction vessel during the polymerization reaction. Another variant is the addition of the alkyl and aryl alkoxylates according to the invention after the polymerization reaction has ended to improve the stability of the polymer dispersion.

The alkyl and aryl alkoxylates according to the invention can either be used on their own or in combination with other already known anionic and nonionic emulsifiers of the prior art, as were described at the outset. The amount of anionic and nonionic emulsifiers of the prior art is then preferably 0.05 to 5% by weight, in particular 0.08 to 3% by weight and particularly preferably 0.1 to 2% by weight, based on the weight of the water-insoluble or sparingly water-soluble monomers.

In a particularly preferred embodiment, the alkyl and aryl alkoxylates of the formula (1) according to the invention are used in combination with anionic emulsifiers.

In general, the alkyl and aryl alkoxylates of the formula (1) according to the invention are used in amounts of from 0.1 to 10% by weight, preferably 0.2 to 5% by weight, in particular 0.4 to 4% by weight, based on the weight of the water-insoluble or sparingly water-soluble monomers used for the preparation of the polymer dispersion, as emulsifiers.

The polymer dispersions prepared using the alkyl and aryl alkoxylates according to the invention exhibit low coagulation during and after polymerization and an improvement in the shear, thermal and storage stability, the freeze/thaw stability and the electrolyte stability toward di- and trivalent cations, such as calcium, barium and aluminum. In addition, an improvement in the film properties of the polymer films prepared from the polymer dispersions can be observed. The polymer dispersions prepared using the alkyl and aryl alkoxylates according to the invention form films with low water absorption, low blushing upon contact with water and good wet and dry rubbing fastnesses.

### EXAMPLES

1. Vinyl Acetate Dispersion

1 700 g of a monomer emulsion consisting of 473.2 g of demineralized water, 2.8 g of Netzer SB 10 (65% strength solution of sodium diisodecyl-sulfosuccinate in a water/isopropanol mixture, Clariant GmbH), 24 g of an n-butyl alkoxylate according to the invention with 4 mol of propylene oxide and 30 mol of ethylene oxide, 300 g of ®VeoVa10 (vinyl isodecanoate, Shell) and 900 g of vinyl acetate, and an initiator solution consisting of 3.6 g of potassium peroxodisulfate and 304.4 g of demineralized water are prepared.

356.9 g of demineralized water are initially introduced into a 3 liter reaction vessel and, with stirring with an anchor stirrer, 2.8 g of Netzer SB 10 (65% strength solution of sodium diisodecylsulfosuccinate in a water/isopropanol mixture), 24.0 g of ®Tylose H 200 YG4 (hydroxyethylcellulose, Clariant GmbH), 6.0 g of borax, 2.6 ml of acetic acid, 170 g of the monomer dispersion prepared previously and 92.3 g of the initiator solution are added one after the other. The emulsion is then heated to 76° C. in a water bath under a nitrogen atmosphere so that the free-radical polyaddition reaction starts. The reaction temperature is kept constant at 79 to 81° C. by cooling or heating via the water bath. After 15 minutes, the remaining 1 530 g of the monomer emulsion are added over a period of 3 hours. To initiate the free-radical polyaddition reaction, the remaining 215.7 g of the initiator solution are added via a second feed over the course of a period of 3 hours and 15 minutes. Subsequently, the reaction mixture is stirred for a further 2 hours at 80° C. with stirring and under a nitrogen atmosphere and then cooled to room temperature. For preservation, 3.6 g of ®Nipacide CI15, Nipa Laboratories Ltd. are added to the prepared polymer dispersion.

The resulting polymer dispersion has a solids content of 50% and a coagulum of <0.010% through a 100 μm sieve and of <0.015% through a 40 μm sieve.

2. Styrene/acrylate Dispersion

1 700 g of a monomer emulsion consisting of 531.7 g of demineralized water, 29.3 g of ®Emulsogen EPA 073 (sodium alkylpolyethylene glycol ether sulfate, Clariant GmbH), 22 g of an n-butyl alkoxylate having 4 mol of propylene oxide and 30 mol of ethylene oxide according to the invention, 6 g of sodium hydrogen carbonate, 360 g of styrene, 500 g of n-butyl acrylate, 240 g of methyl acrylate and 11 g of methacrylic acid, and an initiator solution consisting of 5.55 g of ammonium peroxodisulfate and 142.5 ml of demineralized water are prepared.

344.5 g of demineralized water are initially introduced into a 3 liter reaction vessel, and 7.3 g of Emulsogen EPA 073 (sodium alkylpolyethylene glycol ether sulfate) are added. The emulsifier solution is heated to 80° C. in the reaction vessel under a nitrogen atmosphere and stirring using an anchor stirrer. 37 ml of initiator solution and 42.5 ml of the monomer emulsion are then added. The free-radical polyaddition reaction starts. The reaction mixture is cooled and kept constant at 79-81 ° C. via the water bath. The remaining 1 657.5 g of the monomer emulsion and 111 g of the initiator solution are added over a period of 3 hours. Then, by means of the water bath, the reaction mixture is kept at 80° C. for a further hour and then cooled to room temperature. The pH of the prepared polymer dispersion is adjusted to pH 7-8 with 12.5% strength ammonia solution.

The resulting polymer dispersion has a solids content of 51% and a coagulum of <0.010% through a 100 μm sieve and of <0.015% through a 40 μm sieve.

3. Straight Acrylate Dispersion

1 800 g of a monomer emulsion consisting of 341.2 g of demineralized water, 72.3 g of Emulsogen EPA 073 (sodium alkylpolyethylene glycol ether sulfate), 20.3 g of a methyl alkoxylate having, on average, 3.2 mol of propylene oxide and 40 mol of ethylene oxide according to the invention, 2.2 g of dodecyl mercaptan, 150 g of methyl methacrylate, 350 g of 2ethylhexyl acrylate, 850 g of n-butyl acrylate and 14 g of methacrylic acid, and 57 g of an initiator solution consisting of 7.1 g of ammonium peroxodisulfate and 49.9 g of demineralized water are prepared.

263 g of demineralized water are initially introduced into a 3 liter reaction vessel and heated to 80° C. over a water bath under a nitrogen atmosphere. Subsequently, 17 g of the initiator solution are added, and the continuous addition of the 1 800 g of monomer emulsion and the remaining 40 g of initiator solution is started immediately. The metered addition of the two components takes place with continuous stirring using an anchor stirrer and under a nitrogen atmosphere over a period of 3 hours. The reaction mixture is then heat-treated at 80° C. for a further hour and then cooled to room temperature. The pH of the prepared polymer dispersion is adjusted to pH 7-8 using 12.5% strength ammonia solution.

The resulting polymer dispersion has a solids content of 65% and a coagulum of <0.10% through a 100 μm sieve and of <0.12% through a 40 μm sieve.

1. The use of compounds of the formula 1 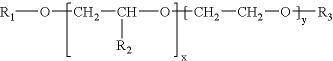
in which
R₁ is an alkyl or alkenyl radical having 1 to 6 carbon atoms or a phenyl, methyl phenyl or dimethyl phenyl radical,
R₂ is a methyl or ethyl radical,
R₃ is a hydrogen atom or a methyl radical,
x is a number from 1 to 50 and
y is a number from 1 to 500,
as emulsifier in emulsion polymerization.

2. The use of compounds as claimed in claim 1, wherein R₃ is a hydrogen atom.

3. The use of compounds as claimed in claim 1 and/or 2, wherein x is a number from 1 to 20.

4. The use of compounds as claimed in one or more of claims 1 to 3, wherein y is a number from 1 to 100.

5. The use of compounds as claimed in one or more of claims 1 to 4, wherein, in the emulsion polymerization, olefinically unsaturated compounds polymerize in aqueous medium with one another by the free-radical addition process.

6. The use of compounds as claimed in one or more of claims 1 to 5, wherein the compounds are used in combination with customary anionic emulsifiers chosen from the group consisting of
sodium, potassium and ammonium salts of fatty acids
sodium alkylsulfonates,
sodium olefinsulfonates,
sodium alkylbenzenesulfonates,
sodium polynaphthalenesulfonates,
sodium dialkyl diphenyl ether disulfonates,
sodium, potassium and ammonium alkyl sulfates,
sodium, potassium and ammonium alkylpolyethylene glycol ether sulfates,
sodium, potassium and ammonium alkylphenol polyethylene glycol ether sulfates,
sodium, potassium and ammonium mono- and dialkyl sulfosuccinates and monoalkyl polyoxethylsulfosuccinates, and
alkylpolyethylene glycol ether phosphoric mono-, di- and triesters and mixtures thereof and alkylphenol polyethylene glycol ether phosphoric mono-, di- and triesters and mixtures thereof, and sodium, potassium and ammonium salts thereof.

7. The use of compounds as claimed in one or more of claims 1 to 5, wherein the compounds are used in combination with customary nonionic emulsifiers chosen from the group consisting of
alkylphenol polyethylene glycol ethers,
alkylpolyethylene glycol ethers,
fatty acid polyethylene glycol ethers,
ethylene/propylene glycol block polymers and
sorbitan ester polyethylene glycol ethers.

8. A process for the preparation of emulsion polymers, wherein the compounds of the formula 1 as in claims 1 to 4 are added to the polymerization mixture before, during or after the polymerization process.

9. The process for the preparation of emulsion polymers as claimed in claim 8, wherein the compounds of the formula 1 as in claims 1 to 4 are used in amounts from 0.1 to 10% by weight, based on the weight of the water-insoluble or sparingly water-soluble monomers used for the preparation of the polymer dispersion.

10. The process for the preparation of emulsion polymers as claimed in claim 8 and/or 9, wherein the compounds of the formula 1 as in claims 1 to 4 are used in combination with anionic emulsifiers, where the amount of anionic emulsifiers is 0.05 to 5% by weight, based on the weight of the water-insoluble or sparingly water-soluble monomers.
